(19) United States
(12) Patent Application Publication
(10) Pub. No.: US 2025/0115794 A1
(43) Pub. Date: Apr. 10, 2025

(54) MOISTURE CURABLE POLYURETHANE HOT-MELT ADHESIVE HAVING IMPROVED HEAT STABILITY

(71) Applicant: SIKA TECHNOLOGY AG, Baar (CH)

(72) Inventors: Paul TONG, Suzhou (CN); Elyes JENDOUBI, Tokyo (JP); Weiming ZHANG, Suzhou (CN)

(73) Assignee: SIKA TECHNOLOGY AG, Baar (CH)

(21) Appl. No.: 18/730,184

(22) PCT Filed: Jan. 17, 2023
(86) PCT No.: PCT/EP2023/051020

§ 371 Date: Jul. 18, 2024

(30) Foreign Application Priority Data
Jan. 21, 2022 (WO) PCT/CN2022/073111

(51) Int. Cl. C09J 175/06; C08G 18/12; C08G 18/20; C08G 18/30; C08G 18/40; C08G 18/42; C09J 133/12; C09J 175/08

(52) U.S. Cl. CPC C09J 175/06; C08G 18/12; C08G 18/2018; C08G 18/307; C08G 18/4018; C08G 18/4202; C08G 18/4211; C08G 18/425; C09J 133/12; C09J 175/08; C08G 2170/20; C09J 2301/304; C09J 2433/00; C09J 2475/00

(57) ABSTRACT

A moisture curable adhesive composition including at least 65 wt.-% of at least one isocyanate-functional polyurethane polymer P obtained by reacting: (a) a polyol composition including (a1) at least one polyester polyol PO1, (a2) at least one polyether polyol PO2, and (b) at least one polyisocyanate PI, wherein the adhesive composition further includes at least one non-functionalized thermoplastic polymer TP having a softening point determined by Ring and Ball method according to ISO 4625 standard of 70-200° C., preferably 75-185° C. The adhesive composition can also be used for bonding of substrates in production of white goods, automotive vehicles, and electronic devices.

### TECHNICAL FIELD

The invention relates to reactive polyurethane hot-melt adhesives having improved heat resistance and to use of the adhesives for bonding of substrates in production of white goods, automotive vehicles, and electronic devices.

### BACKGROUND OF THE INVENTION

Hot-melt adhesives are solvent free adhesives, which are solid at room temperature and which are applied to the substrate to be bonded in form of a melt. After cooling the adhesive solidifies and forms an adhesive bond with the substrate through physically occurring bonding. Conventional hot-melt adhesives are non-reactive adhesives, which soften again upon heating and are, therefore, not suitable to be used at elevated temperatures. Reactive hot-melt adhesives contain polymers with reactive groups that enable chemical curing of the adhesive, for example, by crosslinking of the polymer chains. Due to the chemically cured polymer matrix reactive hot-melt adhesives do not soften upon heating and these adhesives are, therefore, suitable for use also at elevated temperatures. The chemical curing of the polymers can be initiated, for example, by heating or exposing the adhesive composition to water, such as atmospheric moisture. Moisture curing hot-melt adhesives typically contain polymers functionalized with isocyanate or silane groups, which enables crosslinking of the polymer chains upon contact with atmospheric moisture.

Moisture curing polyurethane hot-melt adhesives (PUR-RHM) consist mainly of isocyanate-functional polyurethane polymers, which have been obtained by reacting suitable polyols, typically polyester and/or polyether polyols, with polyisocyanates, where the reaction is conducted at a molar excess of isocyanate (NCO) groups over hydroxyl (OH) groups. The adhesive composition is cured by reaction of the residual isocyanate groups with water, which results in various chain extension and/or crosslinking reactions of the polymers. A fully cured polyurethane hot-melt adhesive comprises urea and/or urethane bonds and, depending on the starting materials used for providing the isocyanate-functional polymer, ester and/or ether bonds. A crosslinked hot-melt adhesive does not remelt when subjected to heating. However, compared to adhesives with high crosslinking density, such as epoxy or silicone adhesives, the moisture curing polyurethane hot-melt adhesives typically have lower heat resistance properties. This disadvantage significantly limits the use of PUR-HMs in many applications, particularly in bonding of components in automotive, white goods, and electronic industry.

There is thus a need for a novel type of moisture curable polyurethane hot-melt adhesive having improved heat resistance. Such adhesives are especially suitable for use in bonding of substrates in production of white goods, automotive vehicles, and electronic devices.

### SUMMARY OF THE INVENTION

The object of the present invention is to provide an adhesive composition, which overcomes or at least mitigates the disadvantages of the prior art moisture curable polyurethane hot-melt adhesives as discussed above.

Particularly, it is an object of the present invention to provide a moisture curable polyurethane hot-melt adhesive composition having improved heat resistance. The cured adhesive composition should also preferably have excellent mechanical properties, particularly a high tensile strength, lap shear strength, and elongation at break as well as low viscosity at typical application temperatures of hot-melt adhesives.

It was surprisingly found out that the objects can be achieved with the features of claim 1.

The core of the present invention is a novel type of moisture curable polyurethane hot-melt adhesive composition comprising at least one isocyanate-functional polyurethane polymer obtained by reacting a polyol composition with a polyisocyanate, wherein the adhesive composition further comprises at least one non-functionalized thermoplastic polymer having a relatively high softening point.

It was surprisingly found out that the addition of a non-functionalized thermoplastic polymer having a relatively high softening point to the adhesive composition not only improves the heat stability of the cured adhesive but also results in improvement of mechanical properties, particularly of the tensile and lap shear strength of the cured adhesive composition.

Other subjects of the present invention are presented in other independent claims. Preferred aspects of the invention are presented in the dependent claims.

### DETAILED DESCRIPTION OF THE INVENTION

The subject of the present invention is an adhesive composition comprising at least one isocyanate-functional polyurethane polymer P obtained by reacting:
a) A polyol composition comprising
   a1) At least one polyester polyol PO1 and
   a2) At least one polyether polyol PO2, and
b) At least one polyisocyanate PI,
wherein the adhesive composition further comprises at least one non-functionalized thermoplastic polymer TP having a softening point determined by Ring and Ball method according to ISO 4625-1:2020 standard of 70-200° C., preferably 75-185° C., more preferably 85-165° C., even more preferably 90-145° C., still more preferably 95-135° C.

The prefix “poly” in substance designations such as “polyol” or “polyisocyanate” refers to substances which in formal terms contain two or more per molecule of the functional group that occurs in their designation. A polyol, for example, is a compound having two or more hydroxyl groups, and a polyisocyanate is a compound having two or more isocyanate groups.

The term “polymer” designates a collective of chemically uniform macromolecules produced by a polyreaction (polymerization, polyaddition, polycondensation) where the macromolecules differ with respect to their degree of polymerization, molecular weight, and chain length. The term also comprises derivatives of said collective of macromolecules resulting from polyreactions, that is, compounds which are obtained by reactions such as, for example, additions or substitutions, of functional groups in predetermined macromolecules and which may be chemically uniform or chemically non-uniform.

The term “functionalized polymer” designates polymers which are chemically modified to contain a functional group on the polymer backbone. In contrast, the term “non-functionalized polymer” designates polymers which are not chemically modified to contain functional groups such as epoxy, silane, sulfonate, amide, or anhydride group on the polymer backbone.

The term “polyurethane polymer” designates polymers prepared by the so called diisocyanate polyaddition process. These also include those polymers which are virtually or entirely free from urethane groups. Examples of polyurethane polymers are polyether-polyurethanes, polyester-polyurethanes, polyether-polyureas, polyureas, polyester-polyureas, polyisocyanurates and polycarbodiimides.

The term “isocyanate-functional polyurethane polymer” designates polyurethane polymers comprising one or more unreacted isocyanate groups. The polyurethane prepolymers can be obtained by reacting excess of polyisocyanates with polyols and they are polyisocyanates themselves. The terms “isocyanate-functional polyurethane polymer” and “polyurethane prepolymer” are used interchangeably.

The term “molecular weight” refers to the molar mass (g/mol) of a molecule or a part of a molecule, also referred to as “moiety”. The term “average molecular weight” refers to number average molecular weight (Mn) or to weight average molecular weight (Mw) of an oligomeric or polymeric mixture of molecules or moieties. The molecular weight may be determined by gel permeation chromatography (GPC) using polystyrene as standard, styrene-divinylbenzene gel with porosity of 100 Angstrom, 1000 Angstrom and 10000 Angstrom as the column and, depending on the molecule, tetrahydrofurane as a solvent, at 35° C., or 1,2,4-trichlorobenzene as a solvent, at 160° C.

The term “average OH-functionality” designates the average number of hydroxyl (OH) groups per molecule. The average OH-functionality of a compound can be calculated based on the number average molecular weight (Mn) and the hydroxyl number of the compound. The hydroxyl number of a compound can be determined by using method as defined in DIN 53 240-2 standard.

The term “open time” designates the length of a time period during which an adhesive applied to a surface of a substrate is still able to form an adhesive bond after being contacted with another substrate.

The “amount of at least one component X” in a composition, for example “the amount of the at least one polyol” refers in the present document to the sum of the individual amounts of all polyols contained in the composition. For example, in case the at least one polyol is a polyester polyol and the composition comprises 20 wt.-% of at least one polyol, the sum of the amounts of all polyester polyols contained in the composition equals 20 wt.-%.

The term “room temperature” refers to a temperature of ca. 23° C.

The adhesive composition is preferably a hot-melt adhesive composition, more preferably a one-component hot-melt adhesive composition. The term “one-component composition” refers in context of the present invention to a composition in which all constituents of the composition are stored in a mixture in the same container or compartment.

The adhesive composition comprises at least one isocyanate-functional polyurethane polymer P obtained by reacting a polyol composition with at least one polyisocyanate PI. The “polyol composition” is understood to comprise all polyols that are used for obtaining the at least one isocyanate-functional polyurethane polymer P.

The polyol composition comprises at least one polyester polyol PO1 and at least one polyether polyol PO2.

Suitable polyester polyols for use as the at least one polyester polyol PO1 include crystalline, partially crystalline, amorphous, and liquid polyester polyols. These can be obtained by reacting dihydric and trihydric, preferably dihydric, alcohols, for example, 1,2-ethanediol, diethylene glycol, triethylene glycol, 1,2-propanediol, 1,3-propanediol, dipropylene glycol, 1,4-butanediol, 1,5-pentanediol, 1,6-hexanediol, 1,8-octanediol, 1,10-decanediol, 1,12-dodecanediol, dimer fatty alcohol, neopentyl glycol, glycerol, 1,1,1-trimethylolpropane or mixtures of the aforesaid alcohols, with organic dicarboxylic acids or tricarboxylic acids, preferably dicarboxylic acids, or their anhydrides or esters, such as succinic acid, glutaric acid, 3,3-dimethylglutaric acid, adipic acid, suberic acid, sebacic acid, undecanedioic acid, dodecanedicarboxylic acid, azelaic acid, maleic acid, fumaric acid, phthalic acid, dimer fatty acid, isophthalic acid, terephthalic acid, and hexahydrophthalic acid, or mixtures of the aforesaid acids. Polyester polyols made from lactones such as from ε-caprolactone, also known as polycaprolactones, are also suitable.

Preferred polyester polyols include those obtained by reacting adipic acid, sebacic acid or dodecanedicarboxylic acid as dicarboxylic acid and hexanediol or neopentyl glycol as dihydric alcohol. Further examples of suitable polyester polyols include polyester polyols of oleochemical origin. Polyester polyols of this type may be prepared, for example, by complete ring opening of epoxidized triglycerides of a fat mixture comprising at least partially olefinically unsaturated fatty acids, with one or more alcohols having 1-12 carbon atoms, and by subsequent partial transesterification of the triglyceride derivatives to give alkyl ester polyols having 1-12 carbon atoms in the alkyl radical. Particularly suitable crystalline and partially crystalline polyester polyols include adipic acid/hexanediol polyester and dodecanedicarboxylic acid/hexanediol polyesters.

Preferably, the at least one polyester polyol PO1 is a at 25° C. solid partially crystalline or crystalline polyester polyol.

According to one or more embodiments, the at least one polyester polyol PO1 has a softening point determined by Ring and Ball method according to ISO 4625-1:2020 standard of at least 85° C., preferably at least 95° C., more preferably at least 105° C., even more preferably at least 110° C.

According to one or more embodiments, the at least one polyester polyol PO1 has a softening point determined by Ring and Ball method according to ISO 4625-1:2020 standard of 85-200° C., preferably 95-175° C., more preferably 105-155° C., even more preferably 110-135° C.

Adhesive compositions comprising an isocyanate-functional polyurethane polymer P obtained by reacting a polyisocyanate PI with a polyol composition comprising the at least one polyester polyol PO1 having a softening point falling within the above cited ranges have been found out to exhibit after curing improved tensile strength and increased thermal resistance.

According to one or more embodiments, the at least one polyester polyol PO1 has a number average molecular weight (Mn) determined by gel permeation chromatography (GPC) using polystyrene as standard of 500-10000 g/mol, preferably 1500-5000 g/mol and/or a hydroxyl number determined according to ISO 4629-2 standard of 10-75 mg KOH/g, preferably 15-50 mg KOH/g.

Suitable at 25° C. solid partially crystalline and crystalline polyester polyols are commercially available, for example, under the trade name Dynacoll® 7300-series (from Evonik Industries).

According to one or more embodiments, the polyol composition a) comprises 10-50 wt.-%, preferably 15-40 wt.-%, more preferably 20-35 wt.-%, based the total weight of the polyol composition a), of the at least one at 25° C. solid polyester polyol PO1.

The polyol composition a) further comprises at least one polyether polyol PO2.

Suitable polyether polyols, also known as polyoxyalkylene polyols, for use as the at least one polyether polyol PO2 include polymerization products of ethylene oxide, 1,2-propylene oxide, 1,2- or 2,3-butylene oxide, tetrahydrofuran or mixtures thereof, optionally polymerized by means of a starter molecule having two or more active hydrogen atoms, such as, for example, water, ammonia or compounds having two or more OH- or NH— groups such as 1,2-ethanediol, 1,2-and 1,3-propanediol, neopentyl glycol, diethylene glycol, triethylene glycol, isomeric dipropylene glycols and tripropylene glycols, isomeric butanediols, pentanediols, hexanediols, heptanediols, octanediols, nonanediols, decanediols, undecanediols, 1,3- and 1,4-cyclohexanedimethanol, bisphenol A, hydrogenated bisphenol A, 1,1,1-trimethylolethane, 1,1,1-trimethylolpropane, glycerol, aniline, and mixtures of the aforesaid compounds. Use can be made both of polyoxyalkylene polyols which have a low degree of unsaturation (measured according to ASTM D-2849-69 and expressed as milliequivalents of unsaturation per gram of polyol (meq/g)), produced for example by means of double metal cyanide complex catalysts (DMC catalysts), and of polyoxyalkylene polyols having a relatively high degree of unsaturation, produced for example by means of anionic catalysts such as NaOH, KOH or alkali metal alkoxides.

Particularly suitable polyether polyols include polyoxyalkylene diols or poly-oxyalkylene triols, especially polyoxyethylene diols or polyoxyethylene triols. Especially suitable are polyoxyalkylene diols or polyoxyalkylene triols, more particularly polyoxypropylene diols and triols, having a number average molecular weight (Mn) in the range of 1000-30000 g/mol, and also polyoxypropylene diols and triols having a number average molecular weight (Mn) of 400-8000 g/mol. Suitable polyether polyols are commercially available, for example, under the trade name of Acclaim®, Desmophene®, and Arcol® (all from Covestro).

According to one or more embodiments, the polyol composition a) comprises 10-50 wt.-%, preferably 15-40 wt.-%, more preferably 20-35 wt.-%, based on the total weight of the polyol composition a), of the at least one polyether polyol PO2.

According to one or more embodiments, the at least one polyether polyol PO2 is a at 25° C. liquid polyether polyol, preferably having a hydroxyl-number determined according to ISO 4629-2 standard of 15-100 mg KOH/g, preferably 35-75 mg KOH/g, more preferably 45-65 mg KOH/g.

It may be preferable that the polyol composition a) further comprises:
a3) At least one at 25° C. liquid polyester polyol PO3.

According to one or more embodiments, the at least one at 25° C. liquid polyester polyol PO3 has a number average molecular weight (Mn) determined by gel permeation chromatography (GPC) using polystyrene as standard of 500-5000 g/mol, preferably 1000-3500 g/mol and/or a hydroxyl-number determined according to ISO 4629-2 standard of 25-150 mg KOH/g, preferably 35-100 mg KOH/g.

According to one or more embodiments, the at least one at 25° C. liquid polyester polyol PO3 is an aromatic polyester polyol, preferably a phthalic anhydride diethylene glycol polyester polyol.

According to one or more embodiments, the polyol composition a) comprises 10-50 wt.-%, preferably 15-40 wt.-%, more preferably 20-35 wt.-%, based on the total weight of the polyol composition a), of the at least one at 25° C. liquid polyester polyol PO3.

Suitable polyisocyanates to be used as the at least one polyisocyanate PI include, for example, aliphatic, cyclo-aliphatic, and aromatic polyisocyanates, especially diisocyanates, particularly monomeric diisocyanates. Non-monomeric diisocyanates such as oligomeric and polymeric products of monomeric diisocyanates, for example adducts of monomeric diisocyanates are also suitable but the use of monomeric diisocyanates is preferred.

The term “monomer” designates a molecule having at least one polymerizable group. A monomeric di- or polyisocyanate contains particularly no urethane groups. In the context of the present invention, oligomers or polymer products of diisocyanate monomers such as adducts of monomeric diisocyanates are not monomeric diisocyanates.

An isocyanate is called “aliphatic” when its isocyanate group is directly bound to an aliphatic, cycloaliphatic or arylaliphatic moiety. The corresponding functional group is therefore called an aliphatic isocyanate group. An isocyanate is called “aromatic” when its isocyanate group is directly bound to an aromatic moiety. The corresponding functional group is therefore called an aromatic isocyanate group.

According to one or more embodiments, the at least one polyisocyanate PI is a diisocyanate, preferably a monomeric diisocyanate, more preferably a monomeric diisocyanate having a number average molecular weight (Mn) determined by gel permeation chromatography (GPC) using polystyrene as standard of not more than 1000 g/mol, preferably not more than 500 g/mol, more preferably not more than 400 g/mol.

Examples of suitable monomeric diisocyanates include, for example, 1,6-hexamethylene diisocyanate (HDI), 2-methylpentamethylene 1,5-diisocyanate, 2,2,4- and 2,4,4-trimethyl-1,6-hexamethylene diisocyanate (TMDI) and mixtures of these isomers, 1,10 decamethylene diisocyanate, 1,12-dodecamethylene diisocyanate, lysine diisocyanate, lysine ester diisocyanate, cyclohexane 1,3-diisocyanate and cyclohexane 1,4-diisocyanate and mixtures of these isomers, 1-methyl-2,4-and-2,6-diisocyanatocyclohexane and mixtures of these isomers (HTDI or H6TDI), 1-isocyanato-3,3,5-trimethyl-5-isocyanatomethylcyclohexane (=isophoronediisocyanate or IPDI), perhydro-2,4′-and-4,4′-diphenylmethane diisocyanate (HMDI or H12MDI) and mixtures of these isomers, 1,4-diisocyanato-2,2,6-trimethylcyclohexane (TMCDI), 1,3-and 1,4-bis(isocyanato-methyl)cyclohexane, m- and p-xylylene diisocyanate (m- and p-XDI) and mixtures of these isomers, m- and p-tetramethyl-1,3- and 1,4-xylylene diisocyanate (m- and p-TMXDI) and mixtures of these isomers, bis(1-isocyanato-1-methylethyl) naphthalene, 2,4- and 2,6-tolylene diisocyanate and mixtures of these isomers (TDI), 4,4′-, 2,4′- and 2,2′-diphenylmethane diisocyanate and mixtures of these isomers (MDI), 1,3- and 1,4-phenylene diisocyanate and mixtures of these isomers, 2,3,5,6-tetramethyl-1,4-diisocyanatobenzene, naphthalene 1,5-diisocyanate (NDI), 3,3′-dimethyl-4,4′-diisocyanatobiphenyl (TODI), and dianisidine diisocyanate (DADI).

According to one or more embodiments, the monomeric diisocyanate is selected from the group consisting of 4,4′-, 2,4′-, and 2,2′-diphenylmethane diisocyanate and mixtures of these isomers (MDI), 2,4- and 2,6-tolylene diisocyanate and mixtures of these isomers (TDI), 1,6-hexamethylene diisocyanate (HDI), and 1-isocyanato-3,3,5-trimethyl-5-isocyanatomethylcyclohexane (IPDI). Furthermore, a person skilled in the art knows that the technical grade products of diisocyanates may frequently contain isomer mixtures or other isomers as impurities. According to one or more embodiments, the monomeric diisocyanate is selected from the group consisting of MDI and IPDI. Suitable monomeric diisocyanates are commercially available, for example, under the trade name of Lupranat® (from BASF) and Desmodur (from Covestro).

Preferably, the at least one isocyanate-functional polyurethane polymer P has an average isocyanate functionality of not more than 3.5, preferably not more than 3.0. The term “average NCO-functionality” designates in the present disclosure the average number of isocyanate (NCO) groups per molecule. The average NCO functionality of a compound can be determined by using the method as defined in ISO 14896-2006 standard method A.

According to one or more embodiments, the at least one isocyanate-functional polyurethane polymer P has an average isocyanate functionality of 1.1-3.5, preferably 1.5-3, more preferably 1.8-2.5.

Preferably, the adhesive composition comprises at least 50 wt.-%, more preferably at least 65 wt.-%, even more preferably at least 75 wt.-%, still more preferably at least 85 wt.-%, based on the total weight of the adhesive composition, of the at least one isocyanate-functional polyurethane polymer P.

According to one or more embodiments, the adhesive composition comprises 50-95 wt.-%, preferably 60-90 wt.-%, more preferably 65-85 wt.-%, even more preferably 70-85 wt.-%, based on the total weight of the adhesive composition, of the at least one isocyanate-functional polyurethane polymer P.

The adhesive composition comprises, in addition to the at least one isocyanate-functional polyurethane polymer P, the at least one non-functionalized thermoplastic polymer TP.

It has been surprisingly found out that the attenuation of storage modulus of a cured polyurethane adhesive composition can be shifted to a higher temperature by using non-functionalized thermoplastic polymers having a relatively high softening temperature as rheology modifiers in the adhesive composition. The addition of functionalized thermoplastic polymers not only results in improved thermal stability, which can be seen as improved lap shear strengths at higher temperatures, but it also has a positive effect on adhesive properties at normal room temperature, particularly in terms of increased tensile strength and lap shear strength.

According to one or more embodiments, the adhesive composition comprises 2.5-30 wt.-%, preferably 5-25 wt.-%, more preferably 7.5-25 wt.-%, even more preferably 7.5-20 wt.-%, still more preferably 10-20 wt.-%, based on the total weight of the hot-melt adhesive composition, of the at least one non-functionalized thermoplastic polymer TP.

According to one or more embodiments, the at least one non-functionalized thermoplastic polymer TP comprises at least one poly(meth)acrylate AC and/or at least one at least one thermoplastic polyurethane TPU.

Generally, the expression “the at least one component X comprises at least one component XN”, such as “the at least one thermoplastic polymer TP comprises at least one poly(meth)acrylate AC” is understood to mean in the context of the present disclosure that a composition comprises one or more poly(meth)acrylates AC as representatives of the at least one thermoplastic polymer TP.

Thermoplastic polyurethanes (TPU) are polyurethane-based thermoplastic elastomers (TPE) that are linear segmented block copolymers composed of alternating hard and soft segments or domains formed by the reaction of (1) diisocyanates with short-chain diols (so-called chain extenders) and (2) diisocyanates with long-chain diols.

The term “(meth)acrylate” designates in the context of the present invention methacrylate or acrylate. The term “poly(meth)acrylate” refers to homopolymers, copolymers, and higher interpolymers of an (meth)acrylate monomer with one or more further (meth)acrylate monomers and/or with one or more further monomers.

It may be preferred that the (meth)acrylate monomers do not contain further functional groups such as hydroxyl- and/or carboxyl groups. However, (meth)acrylate monomers containing further functional groups, particularly hydroxyl-groups, can be used in combination with (meth)acrylate monomers without further functional groups.

Suitable (meth)acrylate monomers include, for example, alkyl(meth)acrylates, such as methyl acrylate, methyl methacrylate, ethyl acrylate, n-butyl acrylate, n-butyl methacrylate, n-pentyl acrylate, n-hexyl acrylate, n-heptyl acrylate, n-octyl acrylate, n-octyl methacrylate, n-nonyl acrylate, lauryl acrylate, stearyl acrylate, behenyl acrylate, and their branched isomers, as for example isobutyl acrylate, 2-ethylhexyl acrylate, 2-ethylhexyl methacrylate, isooctyl acrylate, isooctyl methacrylate, and also cyclohexyl methacrylate, isobornyl acrylate, isobornyl methacrylate or 3,5-dimethyladamantyl acrylate.

Suitable (meth)acrylate monomers with further functional groups include, for example, hydroxyl group containing (meth)acrylate monomers, such as 2-hydroxyethyl(meth)acrylate, 2-hydroxypropyl(meth)acrylate, 3-hydroxypropyl (meth)acrylate, 2-hydroxybutyl(meth)acrylate, 4-hydroxybutyl butyl(meth)acrylate, 2-hydroxy-hexyl(meth)acrylate, 6-hydroxy hexyl(meth) acrylate, 8-hydroxyoctyl(meth)acrylate, 10-hydroxydecyl(meth)acrylate, 12-hydroxylauryl(meth)acrylate.

Further suitable comonomers for the synthesis of the at least one poly(meth)acrylate AC include vinyl compounds, such as ethylenically unsaturated hydrocarbons with functional groups, vinyl esters, vinyl halides, vinylidene halides, nitriles of ethylenically unsaturated hydrocarbons, phosphoric acid esters, and zinc salts of (meth)acrylic acid. Examples of further suitable comonomers include, for example, maleic anhydride, styrene, styrenic compounds, acrylonitriles, vinyl acetate, vinyl propionate, vinyl chloride, (meth)acrylic acid, beta-acryloyloxypropionic acid, vinylacetic acid, fumaric acid, crotonic acid, aconitic acid, trichloroacrylic acid, itaconic acid, and maleic acid, and amides thereof.

Especially suitable poly(meth)acrylates include, for example, homopolymers and copolymers obtained by free radical polymerization of one or more (meth)acrylate monomers optionally in combination with one or more hydroxyl-functional (meth)acrylate monomer and/or at least one further comonomer.

Suitable poly(meth)acrylates are commercially available, for example, under the trade name of Dynacoll® AC, such as Dynacoll® AC 1420, Dynacoll® AC 1520, Dynacoll® AC 1631, Dynacoll® AC 1620, Dynacoll® AC 1630, Dynacoll® AC 1632, Dynacoll® AC 1750, Dynacoll® AC 1920, Dynacoll® AC 4830, and Dynacoll® AC 2740 (all from Evonik Industries).

According to one or more embodiments, the at least one poly(meth)acrylate AC has
an acid number determined according to EN ISO 2114 standard of not more than 25 mg KOH/g, preferably not more than 15 mg KOH/g, more preferably not more than 10 mg KOH/g and/or
a weight average molecular weight (Mw) determined by gel permeation chromatography (GPC) using polystyrene as standard of 15000-100000 g/mol, preferably 25000-65000 g/mol and/or
a glass transition temperature (Tg) determined according to ISO 11357-1:2016 standard of at or above 0° C., preferably at or above 35° C.

According to one or more embodiments, the at least one non-functionalized thermoplastic polymer TP is composed of the at least one poly(meth)acrylate AC.

According to one or more embodiments, the at least one non-functionalized thermoplastic polymer TP comprises at least one thermoplastic polyurethane TPU.

Thermoplastic polyurethanes have been found out to be especially suitable for use as rheology modifiers to improve the thermal resistance of the cured adhesive composition.

According to one or more embodiments, the at least one thermoplastic polyurethane TPU has a glass transition temperature determined according to ISO 11357-1:2016 standard of at or below 0° C., preferably at or below −5° C., more preferably at or below −10° C., even more preferably at or below −15° C.

According to one or more embodiments, the at least one non-functionalized thermoplastic polymer TP is composed of the at least one thermoplastic polyurethane TPU.

According to one or more embodiments, the at least one non-functionalized thermoplastic polymer TP comprises the at least one poly(meth)acrylate AC and the at least one thermoplastic polyurethane TPU, wherein the weight ratio of the amount of at least one poly(meth)acrylate AC to the amount of at least one thermoplastic polyurethane TPU is in the range of 5:1 to 1:5, preferably 3:1 to 1:3, more preferably 2:1 to 1:2.

According to one or more embodiments, the adhesive composition further comprises at least one catalyst CA that catalyzes the reactions of isocyanate groups with water.

Examples of suitable catalysts include metal-based catalysts such as dialkyltin complexes, particularly dibutyltin (IV) or dioctyltin (IV) carboxylates or acetoacetonates, such as dibutyltindilaurate (DBTDL), dibutyltindiacetylacetonate, dioctyltindilaurate (DOTDL), further bismuth (III) complexes such as bismuthoctoate or bismuthneodecanoate, zinc (II) complexes, such as zincoctoate or zincneodecanoate, and zirconium (IV) complexes, such as zirconiumoctoate or zirconiumneodecanoate.

Further examples of suitable catalysts include compounds containing amine groups such as, dimorpholinodialkylethers and/or dimorpholino substituted polyalkylene glycols, for example 2,2′-dimorpholinodiethyl ether and 1,4-diazabicyclo[2.2.2]-octane. Combinations of two or more catalysts may also be used, preferred combinations including of one or more metal-catalysts with one or more morpholine amine compounds.

According to one or more embodiments, the adhesive composition comprises 0.005-2.00 wt.-%, preferably 0.05-1.00 wt.-%, based on the total weight of the adhesive composition, of the at least one catalyst CA.

The adhesive composition of the present invention can further comprise auxiliary substances and additives, for example, those selected from the group consisting of fillers, plasticizers, adhesion promoters, UV absorption agents, UV and heat stabilizers, optical brighteners, pigments, dyes, and desiccants.

Examples of suitable UV stabilizers that can be added to the adhesive composition include, for example, sterically hindered phenols, and suitable UV-absorbers include, for example, hydroxybenzophenones, hydroxybenzotriazoles, triazines, anilides, benzoates, cyanoacrylates, phenylformamidines, and mixtures thereof.

Suitable fillers include inorganic and organic fillers, especially natural, ground or precipitated calcium carbonates, optionally coated with fatty acids or fatty acid esters, especially stearic acid, baryte (heavy spar), talcs, quartz flours, quartz sand, dolomites, wollastonites, kaolins, calcined kaolins, mica (potassium aluminum silicate), molecular sieves, aluminum oxides, aluminum hydroxides, magnesium hydroxide, silicas including finely divided silicas from pyrolysis processes, industrially produced carbon blacks, graphite, metal powders such as aluminum, copper, iron, silver, steel, polyvinylchloride powder, and hollow spheres.

The total amount of such auxiliary substances and additives is preferably not more than 15 wt.-%, more preferably not more than 10 wt.-%, based on the total weight of the adhesive composition.

According to one or more embodiments, the adhesive composition is obtained by a method comprising steps of:
A) Providing the polyol composition a) and the at least one non-functionalized thermoplastic polymer TP in a reactor,
B) Adding to the mixture obtained from step A) the at least one isocyanate PI and conducting reaction, optionally in the presence of one or more catalysts, wherein the molar ratio between isocyanate groups and hydroxyl groups is at least 1.1, preferably at least 1.3, to obtain a reaction mixture comprising the at least one isocyanate-functional polyurethane polymer P.

According to one or more embodiments, the NCO/OH ratio in step B) of the method is not greater than 3.5, preferably not greater than 3.0, more preferably not greater than 2.75, particularly 1.3-2.75, preferably 1.5-2.5.

The reaction conducted in step B) will convert substantially all the hydroxyl groups of the polyol composition a), for example at least 95%, preferably at least 99%, of the hydroxyl groups of the polyol a) composition.

Preferably, the starting mixture provided in step A) is dehydrated under vacuum at a temperature of at or above 120° C. before conducting step B).

The reaction in step B) may be carried out according conventional methods used for preparation of isocyanate-functional polyurethane polymers. The reaction may, for example, be carried out at temperatures in the range of 50-160° C., preferably 60-120° C., optionally in the presence of a catalyst. The reaction time depends on the temperature employed, but may, for example, be in the range of from 30 minutes to 6 hours, particularly from 30 minutes to 3 hours, preferably from 30 minutes to 1.5 hours. Suitable catalysts used in the reaction of step B) include, for example, metal catalysts, such as Coscat®83 (from Vertellus Performance Materials Inc.), and tin catalysts.

The adhesive composition of the present invention is a moisture-curing adhesive composition, i.e., the adhesive composition can be cured by contacting the composition with water, especially with atmospheric moisture.

Furthermore, the adhesive composition of the present invention has good workability under typical application conditions of hot-melt adhesives, particularly at temperatures in the range of 85-200° C., meaning that at the application temperature the adhesive has sufficiently low viscosity to enable application to a substrate in a molten state. The adhesive composition also develops a high initial strength immediately after the application to a substrate upon cooling even before the initiation of the crosslinking reaction with water, particularly with atmospheric moisture.

According to one or more embodiments, the adhesive composition has a viscosity at a temperature of 110° C. of not more than 25000 mPa·s, preferably not more than 20000 mPa's, more preferably not more than 15000 mPa·s, even more preferably not more than 12500 mPa·s. The viscosity at temperature of 110° C. can be measured using a conventional viscometer at 5 revolutions per minute, for example by using a Brookfield DV-2 viscometer with a spindle No. 27, preferably with a Thermosel System for temperature control.

According to one or more embodiments, the adhesive composition has a softening point measured by Ring and Ball method according to 4625-1:2020 standard in the range of 40-165° C., preferably 45-135° C., more preferably 50-105° C.

The preferences given above for the isocyanate-functional polyurethane polymer P, the polyol composition, the polyester polyol PO1, the polyether polyol PO2, the polyester polyol PO3, the non-functionalized thermoplastic polymer TP, and the catalyst CA apply equally to all subjects of the present invention unless stated otherwise.

Another subject of the present invention is use of the adhesive composition of the present invention for bonding of substrates in production of white goods, automotive vehicles, and electronic devices. Suitable electronic devices in include, for example, displays, cellphones, smart watches, and audio devices.

Another subject of the present invention is a method for adhesively bonding a first substrate to a second substrate, the method comprising steps of:
I) Heating an adhesive composition according to the present invention to provide a melted adhesive composition,
II) Applying the melted adhesive composition to a surface of the first substrate to form an adhesive film,
III) Contacting the adhesive film with a surface of the second substrate, and
IV) Chemically curing the adhesive film with water, preferably with atmospheric moisture.

The first and second substrates can be sheet-like articles having first and second major surfaces defined by peripheral edges and defining a thickness there between or three-dimensional shaped articles.

In the method for adhesively bonding a first substrate to a second substrate, the adhesive composition is heated to a temperature above the softening point of the adhesive composition and applied to the surface of the first substrate in molten state using any conventional technique, for example, by using slot die coating, roller coating, extrusion coating, calendar coating, or spray coating. The adhesive composition can be applied to the surface of the first substrate with a coating weight of, for example, 25-750 g/m², preferably 35-650 g/m², more preferably 45-550 g/m², even more preferably 50-500 g/m².

After the adhesive film has been contacted with the surface of the second substrate, the adhesive composition develops a certain initial adhesive strength by physical curing, i.e., upon cooling. Depending on the application temperature and on the embodiment of the adhesive composition, particularly on the reactivity of the adhesive, the chemical curing reactions may begin already during the application of the adhesive composition on the surface of the first substrate. Typically, however, majority of the chemical curing occurs after the application of adhesive, particularly, after the applied adhesive film has been contacted with the surface of the second substrate.

The first and second substrates can be composed of any conventional material including polymeric material, metal, painted metal, glass, wood, wood derived materials such as natural fiber polypropylene (NFPP), and fiber materials. Suitable polymeric materials include, for example, polyethylene (PE), in particular high density polyethylene (HDPE), polypropylene (PP), glass-fiber reinforced polypropylene (GFPP), polyvinyl chloride (PVC), polyethylene terephthalate (PET), polystyrene (PS), polycarbonate (PC), polymethylmethacrylate (PMMA), acrylonitrile butadiene styrene (ABS), polyamide (PA), and combinations thereof. The first and second substrates can be composed of a single layer or of multiple layers of different types of materials. The layer(s) composed of polymeric materials can further contain additives such as fillers, plasticizers, flame retardants, thermal stabilizers, antioxidants, pigments, dyes, and biocides.

Still another subject of the present invention is a composite element obtainable by using the method for adhesively bonding a first substrate to a second substrate of the present invention.

### EXAMPLES

The followings compounds and products shown in Table 1 were used in the examples.

TABLE 1

| | |
|---|---|
| PO11 | Solid, partially crystalline polyester polyol, softening point 63° C. |
| | (DSC), hydroxyl number 20-40 mg KOH/g (EN ISO 4629-2) |
| PO12 | Solid, partially crystalline polyester polyol, softening point 102° C. |
| | (DSC), hydroxyl number 20-40 mg KOH/g (EN ISO 4629-2) |
| PO13 | Solid, partially crystalline polyester polyol, softening point 118° C. |
| | (DSC), hydroxyl number 20-40 mg KOH/g (EN ISO 4629-2) |
| PO2 | Difunctional polyether polyol, hydroxyl number 50-60 mg KOH/g |
| | (EN ISO 4629-2) |
| PO3 | Liquid phthalic anhydride-diethylene glycol polyester polyol, |
| | hydroxyl number 60-80 mg KOH/g |
| TP1 | Poly(meth)acrylate based on methyl methacrylate and n-butyl |
| | methacrylate, weight average molecular weight (M_{w}) 30000-40000 |
| | g/mol, softening point R&B method 160° C. (ISO 4625) |
| TP2 | Linear polyester-based polyurethane (TPU), softening point R&B |
| | method 100-110° C., glass transition temperature (DSC) −23° C. |
| TP3 | Linear polyester-based polyurethane (TPU), softening point R&B |
| | method 70-75° C., glass transition temperature (DSC) −34° C. |
| PI | 4,4′-diphenylmethane diisocyanate, NCO content 30-40 g/100 g |
| | (ASTM D 5155-96 A) |
| CA | DMDEE (2,2′-dimorpholinodiethylether) |

The adhesive compositions presented in Table 2 were prepared according to the procedures as presented below.

### Preparation of Adhesive Compositions

Solid polyester polyol (PO1), liquid polyether polyol (PO2), liquid polyester polyol (PO3), and non-functionalized thermoplastic polymer (TP) were charged into a stainless-steel reactor.

The mixture was kept under vacuum with stirring at 140° C. for 120 minutes to dewater the components and to obtain a homogeneously mixed mixture. The temperature of the mixture was lowered to 120° C. and polyisocyanate (PI) was added to the mixture under a nitrogen blanket. The thus obtained starting mixture was reacted with stirring for 45 minutes under vacuum at a temperature of 120° C. to obtain a reaction product containing the isocyanate-functional polyurethane polymer. The catalyst (CA) was then added to the reaction product under nitrogen blanket. After mixing for 45 minutes under vacuum, the obtained adhesive composition was stored at room temperature under exclusion of moisture.

### Measurement Methods

The adhesive compositions were characterized using the following measurement methods.

### Viscosity at 110° C.

The sample adhesive composition provided in a sealed tube was preheated in an oven at a temperature of 110° C. for a time period of 30 minutes. After the heating, a sample of 12.3 g of the adhesive composition was weighted and placed in a disposable sleeve to a viscometer. The viscosity was measured at temperature of 110° C. at 5 revolutions per minute using a Brookfield DV-2 viscometer with a spindle No. 27 equipped with a Thermosel system. The values obtained with 20 minutes of tempering at the measurement temperature and five minutes of measurement were recorded as representative viscosities.

### Open Time

The sample adhesive composition provided in a sealed tube was first preheated in an oven to at temperature of 110° C. for a time period of 30 minutes. After the heating, a sample of 20 g of the molten adhesive was applied with a doctor blade to surface of a silicone paper strip (B700 white, Laufenberg & Sohn KG) placed on a heating plate. The silicone paper strip had dimensions of 30 cm×10 cm and the adhesive was applied as a film having a thickness of 500 μm and dimensions of 30 cm×6 cm. Before applying the adhesive film, the silicone paper strip and the doctor blade were heated to a temperature of 110° C. with the heating plate.

Immediately after application of the adhesive, the silicone paper strip was removed from the heating plate and placed (with the adhesive film facing upwards) on a sheet of plywood at room temperature (23° C.) and the time was recorded as the starting point of the measurement. Every 10 seconds a short strip of silicone coated paper having dimensions of 10 cm×1 cm and formed in a roll (non-siliconized surface facing outwards) was placed on the adhesive film and then slowly removed to separate the strip from the adhesive film. The procedure was repeated until the paper strip could not be removed from the adhesive film without damaging the paper strip or the adhesive film. The time interval between the starting point of the measurement and the last sampling point was recorded as the open time (in seconds) of the adhesive composition

The values of open time presented in Table 2 have been obtained as an average of three measurements conducted with the same adhesive composition.

### Tensile Strength and Elongation at Break

The adhesive composition provided in a sealed tube was preheated in an oven to at temperature of 110° C. for a time period of 30 minutes. After the heating, a sample of 40 g of the molten adhesive was applied with a doctor blade to surface of a silicone paper strip (B700 white, Laufenberg & Sohn KG) placed on a heating plate. The silicone paper had dimensions of 60 cm×10 cm and the adhesive was applied as a film having a thickness of 500 μm and dimensions of 60 cm×6 cm. Immediately after the application of the adhesive, the silicone paper strip was removed from the heating plate and stored at standard climatic conditions (23° C., 55% relative humidity) for a period of 7 days.

The measurements were conducted using a method based on DIN 53504 standard. Five rectangular test specimens having dimensions of 2.0 cm×8.0 cm were cut from a cured adhesive film having a thickness of 500 μm (cured for 14 days at 23° C./50% relative humidity). The test specimens were clamped into the tensile testing machine (Zwick Z 020) and pulled apart with a speed of 100 mm/min (test conditions 23° C., 50% relative humidity). The tensile strength and elongation at break were determined based on the measured maximum tensile stress.

The values of tensile strength and elongation at break presented in Table 2 have been obtained as an average of five measurements conducted with the same adhesive composition.

### Tensile Lap-Shear Strength (LSS)

The adhesive composition provided in a sealed tube was preheated in an oven to at a temperature of 110° C. for a time period of 30 minutes. After the heating, a sample of the molten adhesive was applied on the surface of a polycarbonate (PC) substrate having dimensions of 9 cm×2 cm×5 mm. The adhesive was applied as a film having dimensions of 2.5 cm×1 cm and a thickness of 1 mm.

Immediately after the application of the adhesive a second PC substrate having same dimensions as the first PC specimen was positioned over the first PC substrate along the edge of the adhesive film to form a test composite element. The second PC substrate was pressed firmly against the first PC specimen to remove air from adhesive bond. A weigh of 150 g was placed on the top surface of the second PC substrate. Any adhesive squeezed out from the joint was trimmed off with a knife. The test composite element was stored at standard climatic conditions (23° C., 55% relative humidity) for a period of 7 days before measuring of the lap shear strengths.

Lap shear strengths were measured according to EN 1465 standard using a material testing apparatus (Zwick Z 020) and a test speed 10 mm/min. The lap shear strengths obtained after subjecting the test composite element to an artificial aging treatment (500 h, at 65° C. and 85° C.) were also measured to determine the heat and humidity stability of the tested adhesive composition.

The lap shear strength values for each adhesive composition presented in Table 2 have been obtained as an average of three measurements conducted with identical test composite elements prepared by using the same adhesive composition.

TABLE 2

| | Ex-1 | Ref-1 | Ex-2 | Ref-2 | Ex-3 | Ref-3 | Ex-4 | Ex-5 | Ex-6 | Ex-7 | Ex-8 | Ex-9 |
|---|---|---|---|---|---|---|---|---|---|---|---|---|
| Composition [wt.-%] | | | | | | | | | | | | |
| PO11 | 25.0 | 28.51 | | | | | 25.0 | | | 25.0 | | |
| PO12 | | | 25.0 | 28.51 | | | | 25.0 | | | 25.0 | |
| PO13 | | | | | 25.0 | 28.51 | | | 25.0 | | | 25.0 |
| PO2 | 25.0 | 28.51 | 25.0 | 28.51 | 25.0 | 28.51 | 25.0 | 25.0 | 25.0 | 25.0 | 25.0 | 25.0 |
| PO3 | 20.0 | 22.81 | 20.0 | 22.81 | 20.0 | 22.81 | 20.0 | 20.0 | 20.0 | 20.0 | 20.0 | 20.0 |
| TP1 | 12.3 | | 12.3 | | 12.3 | | | | | | | |
| TP2 | | | | | | | 12.3 | 12.3 | 12.3 | | | |
| TP3 | | | | | | | | | | 12.3 | 12.3 | 12.3 |
| PI | 17.5 | 19.95 | 17.5 | 19.95 | 17.5 | 19.95 | 17.5 | 17.5 | 17.5 | 17.5 | 17.5 | 17.5 |
| CA | 0.2 | 0.23 | 0.2 | 0.23 | 0.2 | 0.23 | 0.2 | 0.2 | 0.2 | 0.2 | 0.2 | 0.2 |
| Total | 100.0 | 100.00 | 100.0 | 100.00 | 100.0 | 100.00 | 100.0 | 100.0 | 100.0 | 100.0 | 100.0 | 100.0 |
| Measured properties | | | | | | | | | | | | |
| Viscosity @110° C. [cps] | 3000 | 1500 | 3500 | 1800 | 4000 | 1800 | 6000 | 7000 | 7500 | 8000 | 9000 | 9500 |
| Open time [min] | 5 | 6 | 4 | 7 | 3 | 5 | 6 | 6 | 5 | 6 | 6 | 5 |
| Tensile strength at break | 10.12 | 8.17 | 11.23 | 10.54 | 13.45 | 11.65 | 13.45 | 14.23 | 15.38 | 12.37 | 13.27 | 14.57 |
| [MPa] | | | | | | | | | | | | |
| Elongation at break [%] | 1036 | 1100 | 1160 | 900 | 890 | 800 | 900 | 880 | 800 | 900 | 830 | 800 |
| LSS PC/PC @23° C. | 9.32 | 7.34 | 10.47 | 9.67 | 11.34 | 10.88 | 10.97 | 11.32 | 12.43 | 9.43 | 10.36 | 12.66 |
| [MPa] | | | | | | | | | | | | |
| LSS PC/PC @80° C. | 1.32 | 0.98 | 1.57 | 1.24 | 2.31 | 1.87 | 1.87 | 2.45 | 4.32 | 1.48 | 2.34 | 3.65 |
| [MPa] | | | | | | | | | | | | |

1. An adhesive composition comprising at least 65 wt.-% of at least one isocyanate-functional polyurethane polymer P obtained by reacting:
a) a polyol composition comprising
a1) at least one polyester polyol PO1,
a2) at least one polyether polyol PO2, and
b) at least one polyisocyanate PI,
wherein the adhesive composition further comprises at least one non-functionalized thermoplastic polymer TP having a softening point determined by Ring and Ball method according to ISO 4625-1:2020 standard of 70-200° C.

2. The adhesive composition according to claim 1, wherein the at least one polyester polyol PO1 has a softening point determined by Ring and Ball method according to ISO 4625-1:2020 standard of at least 85° C.

3. The adhesive composition according to claim 1, wherein the at least one polyether polyol PO2 is a at 25° C. liquid polyether polyol.

4. The adhesive composition according to claim 1, wherein the polyol composition a) further comprises:
a3) at least one at 25° C. liquid polyester polyol PO3.

5. The adhesive composition according to claim 4, wherein the at least one at 25° C. liquid polyester polyol PO3 is an aromatic polyester polyol.

6. The adhesive composition according to claim 1, wherein the at least one polyisocyanate PI is a diisocyanate.

7. The adhesive composition according to claim 1 comprising at least 75 wt.-%, based on the total weight of the adhesive composition, of the at least one isocyanate-functional polyurethane polymer P.

8. The adhesive composition according to claim 1 comprising 2.5-30 wt.-%, based on the total weight of the hot-melt adhesive composition, of the at least one non-functionalized thermoplastic polymer TP.

9. The adhesive composition according to claim 1, wherein the at least one non-functionalized thermoplastic polymer TP comprises at least one poly(meth)acrylate AC and/or at least one at least one thermoplastic polyurethane TPU.

10. The adhesive composition according to claim 9, wherein the at least one poly(meth)acrylate AC has an acid number determined according to EN ISO 2114 standard of not more than 25 mg KOH/g.

11. The adhesive composition according to claim 9, wherein the at least one thermoplastic polyurethane TPU has a glass transition temperature determined according to ISO 11357-1:2016 standard of at or below 0° C.

12. The adhesive composition according to claim 9, wherein the at least one non-functionalized thermoplastic polymer TP is composed of the at least one thermoplastic polyurethane TPU.

13. The adhesive composition according to claim 1 further comprising at least one catalyst CA that catalyzes the reactions of isocyanate groups with water.

14. The adhesive composition according to claim 13 comprising 0.005-2.00 wt.-%, based on the total weight of the adhesive composition, of the at least one catalyst CA.

15. (canceled)

16. A method for adhesively bonding a first substrate to a second substrate, the method comprising steps of:
I) heating an adhesive composition according to claim 1 to provide a melted adhesive composition,
II) applying the melted adhesive composition to a surface of the first substrate to form an adhesive film,
III) contacting the adhesive film with a surface of the second substrate, and
IV) chemically curing the adhesive film with water.
